(19) United States
(12) Patent Application Publication
(10) Pub. No.: US 2025/0292541 A1
(43) Pub. Date: Sep. 18, 2025

(54) SYSTEM AND METHOD TO DETECT ROAD ANOMALIES

(71) Applicants: KING FAHD UNIVERSITY OF PETROLEUM AND MINERALS, Dhahran (SA); Saudi Data and Artificial Intelligence Authority (SDAIA), Riyadh (SA)

(72) Inventors: Ali Zuhair A. ALMAKHLUK, Dhahran (SA); Uthman BAROUDI, Dhahran (SA)

(73) Assignees: KING FAHD UNIVERSITY OF PETROLEUM AND MINERALS, Dhahran (SA); Saudi Data and Artificial Intelligence Authority (SDAIA), Riyadh (SA)

(21) Appl. No.: 18/605,496

(22) Filed: Mar. 14, 2024

(51) Int. Cl. G06V 10/764; G01C 21/36; G06T 7/50; G06T 7/62; G06V 20/56

(52) U.S. Cl. CPC G06V 10/764; G01C 21/3697; G06T 7/50; G06T 7/62; G06V 20/588; G06T 2207/10016; G06T 2207/20081; G06T 2207/30242; G06T 2207/30261

(57) ABSTRACT

A system and a non-transitory computer-readable storage medium for executing a method of detecting road anomalies is disclosed. The method includes obtaining a live feed from an end computing device in a vehicle travelling on a road using a camera associated with the end computing device, and inputting the live feed to a machine learning model trained to detect and classify a road anomaly such as potholes, longitudinal cracks, transverse cracks, or alligator cracks on the road. The method further includes determining multiple features of the detected road anomaly such as a size of the road anomaly. The method further includes assessing severity of the road anomaly based on features, and transmitting, via a roadside computing device installed on the road, a notification such as a message, an image, a location, or severity of the road anomaly, to multiple end computing devices in the proximity of the roadside computing device.

### BACKGROUND

### Technical Field

The present disclosure is directed to detecting road anomalies such as potholes and cracks, and more particularly relates, to a system and a method to detect road anomalies.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Road users, such as automobiles, bikes, or cyclists, always demand that thoroughfares receive timely and appropriate maintenance. Weather conditions, such as heat and cold, create suitable conditions for a steady deterioration of roads. In addition to weather conditions, other factors such as high traffic volumes, population density of road users, and types of vehicles (i.e., heavy traveling vehicles-HTV or light traveling vehicles-LTV) can contribute to the deterioration leading to faults such as cracks or potholes. Presently, people are increasingly concerned about the condition of the roads they use. Consequently, it is important to monitor and maintain the surfaces of these roads in an efficient and cost-effective manner. Road accidents are closely linked to road conditions, and the presence of potholes, cracks, and bumps can significantly impact driving styles, potentially leading to numerous undesirable situations. In fact, according to a 2018 report survey by the World Health Organization (WHO), around 1.35 million people lose their lives in road accidents annually.

Road inspection generally involves numerous cost-effective measures, such as dedicated vehicles, human inspection, and, obviously, time. A plurality of roads is traversed by the human inspector, and based upon the severity level of road deterioration, the inspector accordingly ranks roads and/or potholes, assigning repair tasks to the workforce. The laborious procedure of road inspection is manual in nature, requiring humans to inspect and is time-consuming.

There are plurality of existing automated methods or system to tackle the laborious procedure of detecting crack or pothole, such as using a vehicle or UAV for inspection. For example, KR2084668B1 describes a system and method of providing road hazard information. The system uses a vehicle mounted camera for inspecting the road. The collected images are transmitted to a server for inspection. A classification unit classifies the images into a pothole based image or a non-pothole based image along with photographing location, date information and the photographing information provided from the information collecting device, and the location type, shape type, length type and calculated depth classified in the type classification unit. A public data analysis unit is also configured to analyze the population information, density, road grade near the photographed image of road. A priority management determination unit is configured to decide the priority of road repair based upon severity level of deterioration of roads. Finally, a map showing potholes and their locations is provided.

US20220101272A1 describes a system for road maintenance analysis. The roadways are scanned by a camera-mounted drone or a light aircraft. Scanned images are transmitted to a server where the server analyzes the images using a machine learning algorithm for presence of potholes. Another machine learning algorithm analyzes the road distress data and combines it with data that most affect road quality such as, maintenance type, traffic volume and flow, environmental factors, census data, and both current and prospective budget constraints. The system would then deliver planning criteria for anticipated road maintenance on a map.

WO2021186387A1 discloses determining road anomalies by analyzing a video of a road taken through a capturing unit mounted on vehicles. The capturing unit is configured to capture the video of the entire road, and corresponding GPS coordinates through a GPS logger. An AI-based central server is configured to identify various road conditions based on different parameters. The reference classifies the quality of roads as good, bad, or worse and determines the right speed to cross the road anomaly 108 based on recent driver experience.

Each of the aforementioned references suffers from one or more drawbacks hindering their adoption. For example, the patent reference KR2084668B1 does not disclose any machine-learning techniques to analyze the images for road inspection. US20220101272A1 does not disclose the identification of pothole features, such as data related to the number and/or size of potholes. WO2021186387A1 discloses the notification of the severity of road conditions exclusively to the subscribed driver, rather than to all neighboring vehicles. Also, most research papers in this field claim to classify anomalies as either potholes or non-potholes, with few differentiating between road anomalies such as cracks or potholes. Consequently, there is a dire need for a system or method capable of efficiently identifying one or more road anomalies, along with their features. The system or method should not only inform subscribed drivers but also reach every road user near the affected road, including those who are traveling or intend to travel on it. This approach aims to address limitations encountered in prior art studies.

### SUMMARY

In an exemplary embodiment, a method of detecting road anomalies is disclosed. The method includes obtaining visual data from an end computing device in a vehicle travelling on a road. The visual data is a live feed captured using a camera associated with the end computing device. The method further includes inputting the visual data to a machine learning (ML) model trained to detect and classify a road anomaly. The road anomaly includes a pothole, longitudinal cracks, transverse cracks, or alligator cracks on the road. The method further includes determining multiple features of the detected road anomaly. The features include a size of the road anomaly. The method further includes assessing a severity of the road anomaly based on the features. The method further includes transmitting, via a roadside computing device installed on the road, a notification to multiple end computing devices in the proximity of the roadside computing device. The notification is an anomaly-specific notification that includes at least one of a message indicating a presence of the road anomaly, an image of the road anomaly, a location of the road anomaly, or a severity of the road anomaly.

In another exemplary embodiment, a non-transitory computer-readable storage medium for storing computer-readable instructions that, when executed by a computer, cause the computer to perform a method for detecting the road anomalies is disclosed. The method includes obtaining visual data from an end computing device installed in a vehicle travelling on a road. The visual data is a live feed captured using a camera associated with the end computing device. The method further includes inputting the visual data to a machine learning (ML) model trained to detect and classify a road anomaly. The road anomaly includes a pothole, longitudinal cracks, transverse cracks, or alligator cracks on the road. The method further includes determining multiple features of the detected road anomaly. The features include a size of the road anomaly. The method further includes assessing a severity of the road anomaly based on the features. The method further includes sending a first signal to a roadside computing device installed on the road to transmit an anomaly-specific notification to multiple end computing devices in the proximity of the roadside computing device. The anomaly-specific notification includes at least one of a message indicating a presence of the road anomaly, an image of the road anomaly, a location of the road anomaly, or a severity of the road anomaly

In another exemplary embodiment, a system comprising a memory storing set of instructions and a processor configured to execute the set of instructions to cause the system to perform a method for detecting the road anomalies is disclosed. The method includes obtaining visual data from an end computing device installed in a vehicle travelling on a road. The visual data is a live feed captured using a camera associated with the end computing device. The method further includes inputting the visual data to a machine learning (ML) model trained to detect and classify a road anomaly. The road anomaly includes a pothole, longitudinal cracks, transverse cracks, or alligator cracks on the road. The method further includes determining multiple features of the detected road anomaly. The features include a size of the road anomaly. The method further includes assessing a severity of the road anomaly based on the features. The method further includes causing a roadside computing device installed on the road to transmit a notification to multiple end computing devices in the proximity of the roadside computing device. The notification includes at least one of a message indicating a presence of the road anomaly, an image of the road anomaly, a location of the road anomaly, or a severity of the road anomaly.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary illustration of an environment that includes one or more electronic systems to detect one or more road anomalies, according to certain embodiments.

FIG. 2 illustrates a general block diagram of a system for identifying one or more road anomalies, according to certain embodiments.

FIG. 3A illustrates an exemplary illustration of a method for identifying one or more anomaly 108 on the road using a first mode, according to certain embodiments.

FIG. 3B illustrates an exemplary illustration of a method for identifying one or more anomaly 108 on the road using a second mode, according to certain embodiments.

FIG. 4 illustrates video footage displayed on the roadside computing device according to certain embodiments.

FIG. 5 illustrates an exemplary video footage at plurality of location of roads, according to certain embodiments.

FIG. 6 illustrates an exemplary warning notification, according to certain embodiments.

FIG. 7 illustrates a storage environment on the cloud server to store the road anomaly data, according to certain embodiments.

FIG. 8 illustrates an exemplary prototype of an anomaly detection system, according to certain embodiments.

FIG. 9 illustrates a flowchart of a method of detecting road anomalies, according to certain embodiments.

FIG. 10 is an illustration of a non-limiting example of details of computing hardware used in the computing system, according to certain embodiments.

FIG. 11 is an exemplary schematic diagram of a data processing system used within the computing system, according to certain embodiments.

FIG. 12 is an exemplary schematic diagram of a processor used with the computing system, according to certain embodiments.

FIG. 13 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Further, the terms “anomaly” and “road anomaly” represent same terms and used throughout the disclosure synonymously.

Further, the terms “end computing device” and “first electronic system” represent same terms and used throughout the disclosure synonymously.

Further, the terms “roadside unit”, “roadside computing device”, “second computing device” and “second electronic system” represent same terms and used throughout the disclosure synonymously.

Further, the terms “Mode 1”, “First mode” and “Mode I” represent same terms and used throughout the disclosure synonymously.

Further, the terms “Mode 2”, “Second mode” and “Mode II” represent same terms and used throughout the disclosure synonymously.

Further, the terms “first end computing device” and “other end computing device” represent same terms and used throughout the disclosure synonymously.

The present disclosure provides a system, a method and a non-transitory computer readable medium configured to perform an edge-based technique for anomaly detection and classification using vision-based methods to provide instant vehicle warnings leveraging edge computing capabilities. An end node that represents a surveillance vehicle is configured to scan road surface, collect visual data using camera and process the visual data to detect road anomalies such as potholes and cracks. The surveillance vehicle then classifies each type of road anomaly based on its features. The surveillance vehicle is also configured to classify anomalies into multiple (e.g., four) categories such as potholes, longitudinal cracks, transverse cracks, and alligator cracks. When a relatively large anomaly 108 is detected, the surveillance vehicle is configured to broadcast, via a roadside unit, an alert or warning message to all nearby vehicles who are currently travelling on it or those who intend to travel on it. Images and or video of identified potholes and cracks are also uploaded to a server where associated authority can take necessary action to repair the affected road in time-efficient manner. A detailed aspect of the invention is provided in depth in the following description.

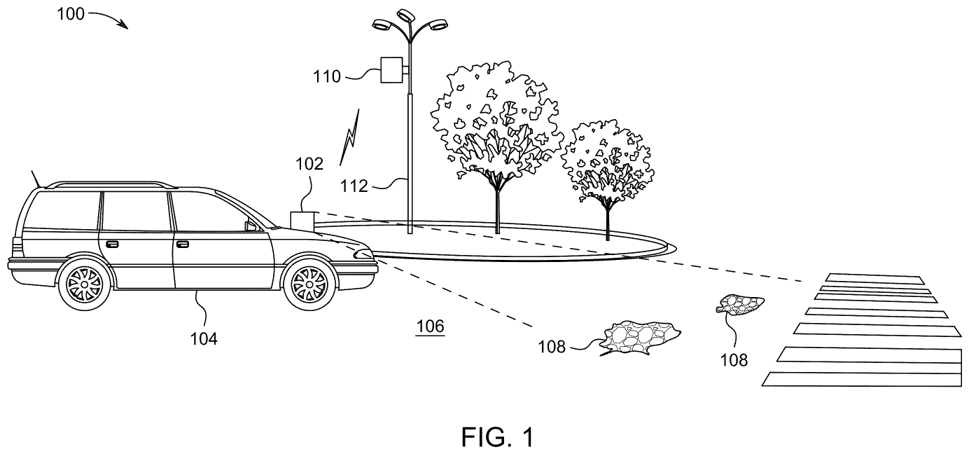

FIG. 1 is an exemplary illustration of an environment 100 that includes one or more electronic systems to detect one or more road anomalies, according to an embodiment. A first electronic system in the environment 100 is an end computing device 102. The end computing device 102 is mounted on, or installed in, a vehicle 104. The vehicle 104 may also be considered as a surveillance vehicle. The end computing device 102 may be mounted on a front or back of the vehicle, pointing towards the road surface to capture video or an image of the road 106. The end computing device 102 includes an image-capturing device (not shown) and associated image processing circuitry electrically connected to the image capturing device and configured to capture the image or visual data of a live feed of a road 106 to identify one or more anomalies 108 when the vehicle 104 moves on the road 106. The end computing device 102 may be in a form of an enclosure to enclose the image capturing device and the associated image processing circuitry. The image capturing device may be selected from a group containing, but not limited to, a 2D camera, a 3D camera, infrared camera, TOF camera, RGB camera or the like, for capturing images or a video stream. In some examples, the image capturing device may refer to a dashcam.

In an embodiment, the end computing device 102 may be mounted inside the vehicle to protect the end computing device 102 from rain, dust, adverse environment etc. When the end computing device 102 is mounted inside the vehicle, the end computing device 102 is positioned to obtain a clear vision of the road 106, such as, in front of the end computing device 102. The image capturing device may have high definition lenses (e.g., 1080p), a wide dynamic range (WDR) (e.g., 140 degree viewing angle covering) function which may be configured to adjust according to the ambient light, built in G-sensor for image stabilization in case of shock or jerk. Furthermore, the end computing device 102 may include a battery, cell, or solar panel-based power supply to power to all electrical components of the end computing device 102. Also, the vehicle 104 is only exemplary illustrated as a car over which the end computing device 102 is mounted. However, the vehicle 104 may be selected from the group containing, but not limited to, any utility vehicle deployed by municipal committees or commercial vehicles such as trucks, buses, or even bikes. Also, the vehicle may be an autonomous vehicle or a human operated vehicle. In another exemplary embodiment, the vehicle may even refer to a flying based object, such as quadrotor, quadcopter, drone, unmanned aerial vehicle (UAV), automatic flying vehicle, automated aircraft, multicopter or the like, over which the end computing device 102 may be mounted to capture visual data of the road 106 for inspection. In an embodiment, the end computing device 102 includes raspberry pi 4 based computing system having 8 GB processor.

A second electronic system in the environment 100 is a roadside computing device 110 installed on a road 106, such as on a pole 112. The roadside computing device 110 is communicatively connected with the end computing device 102. As such, the roadside computing device 110 as well as the end computing device 102 both include a wireless communication module to transmit or receive the visual data of the road 106 between each other. In an embodiment, the wireless communication between the roadside computing device 110 and the end computing device 102 could be performed using, but not limited to, infrared, Bluetooth, NFC, Wi-Fi, Li-Fi, 1G, 2G, 3G, 4G, 5G, 6G, 7G, 8G, 9G, 10G based GSM communication techniques, radio communication, IoT, V2X or alike. The roadside computing device 110 is an electronic system configured to collect visual data from the end computing device 102 and alert other nearby end computing device 102 in proximity to the roadside computing device 110 when a potential road anomaly 108 is detected. The roadside computing device 110 refers to an electronic system having capability to perform complex computation, such as a laptop, desktop, a cloud-based system, a central server or alike.

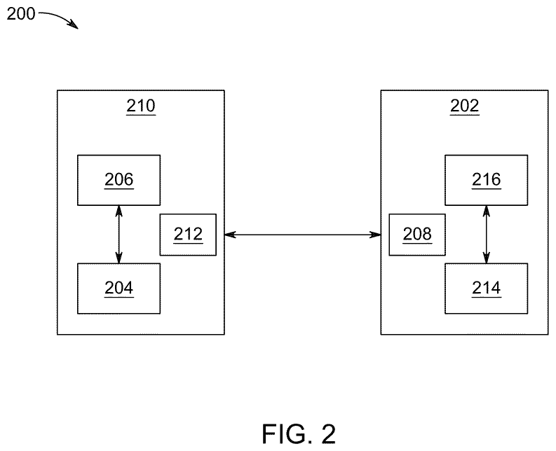

FIG. 2 illustrates a general block diagram of a system 200 for identifying one or more road anomalies, according to an embodiment. The system 200 includes a first electronics system 202 that is representative of the end computing device 102 in FIG. 1. The system 200 further includes a second electronic system 210 that is representative of the roadside computing device 110 in FIG. 1. The first electronics system 202 includes a processor 214 and a memory 216 connected with the processor 214. The second electronics system 210 also includes a processor 204 and a memory 206 connected with the processor 204. Other hardware as required may be connected in both systems as per the computing requirements either individually or in combination. For example, the first electronics system 202 may additionally include a GPS system or use the GPS system of the vehicle 104 over which the first electronics system 202. In an exemplary embodiment, the first electronics system 202 may use the GPS system of cellphones of the occupants travelling by the vehicle 104.

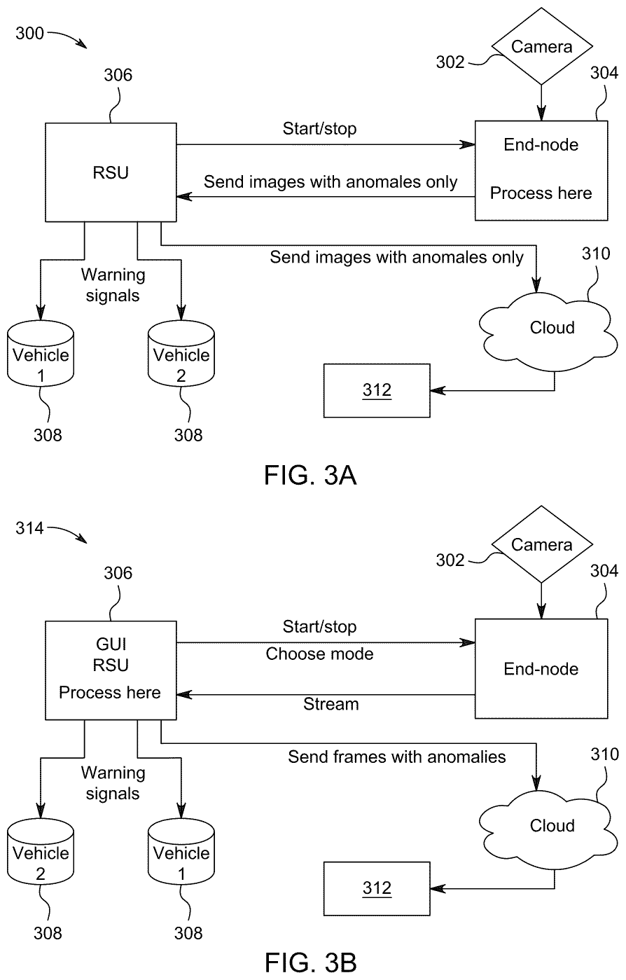

The first electronic system 202 and the second electronic system 210 are communicably connected with each other via a first communication module 208 in the first electronic system 202 and a second communication module 212 in the second electronic system 210. In order to identify one or more anomaly 108 on the road, the first electronic system 202 or the second electronic system 210 is configured to execute a method in the processor 214 or 204, respectively. The processor 214 or 204 can execute the method of identifying the anomaly 108 using two different modes. In a first mode, the visual data is processed in the processor 214 of the end computing device 202 and only subset of the visual data, i.e., frames or images or videos which includes anomaly 108 (e.g., potholes or cracks) are communicated to the roadside computing device 210. This process is explained in detail in FIG. 3A. In a second mode, all the visual data is communicated to the roadside computing device 210 and is processed in the processor 204 of the roadside computing device 210 which is explained in detail in FIG. 3B. Both modes can be selected manually or automatically.

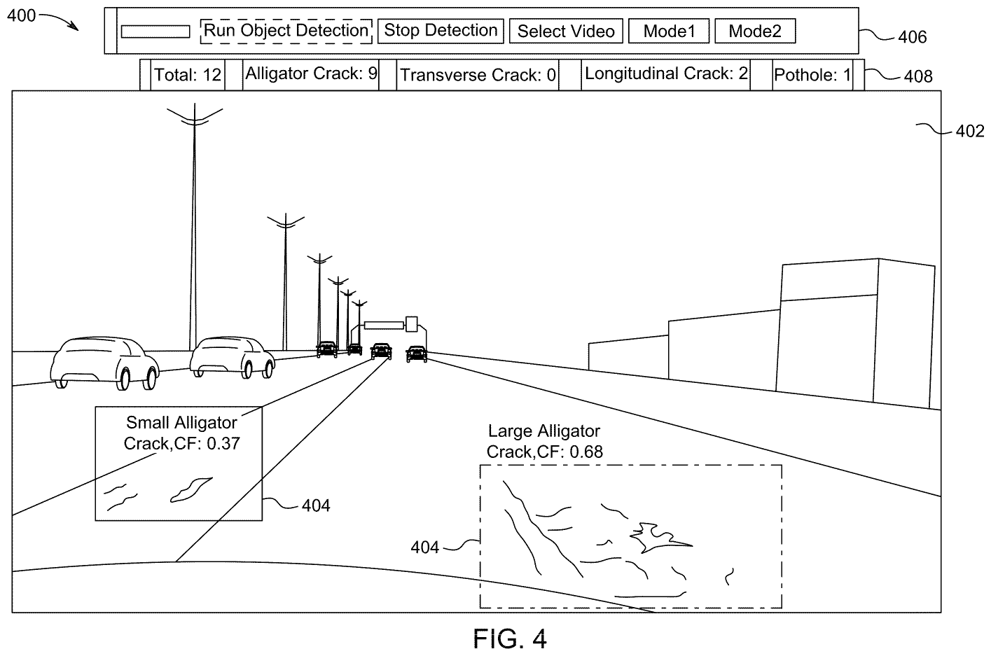

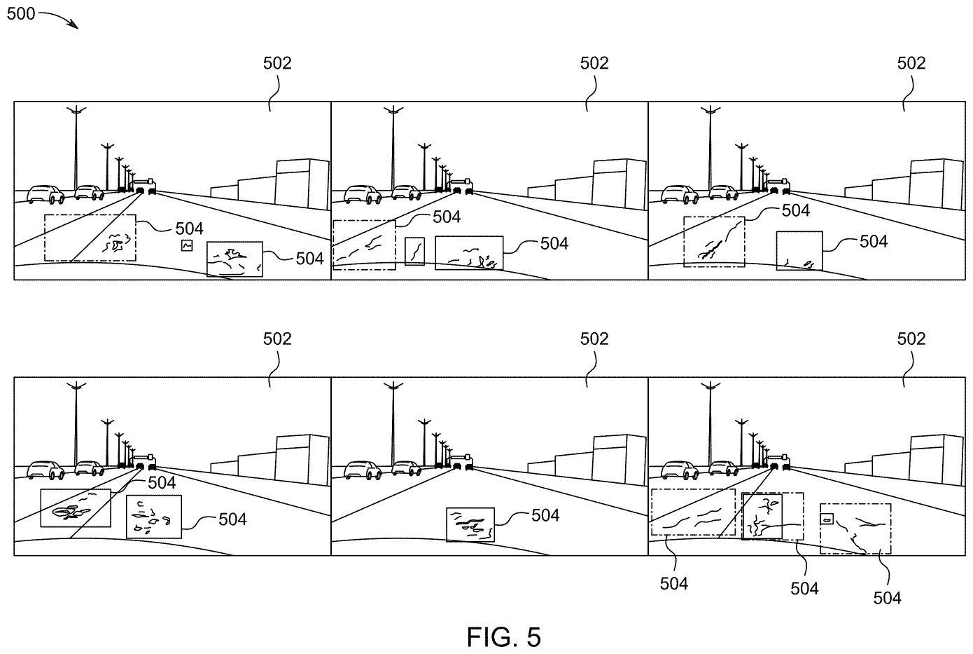

To manually select modes, the second computing device 210 may display a graphical user interface associated with the second electronic system 210 over which a user controls the system operation modes and visualizes the analyzed footage. The system operation modes could be either the first mode or the second mode. For example, any peripheral electronic device, such as a cellphone, mobile, PDA, laptop, desktop or alike may connect, either wired or wirelessly, with the roadside computing device 210 and the peripheral electronic device may display the graphical user interface showing the visual data received from the end computing device 102. The user may select the mode over the graphical user interface to execute. In an embodiment, the roadside computing device 210 could also display the graphical user interface which could be used by the user to select the modes. The detail of the user interface is described in detail in FIG. 4 and FIG. 5. Now the anomaly 108 detection method using the first mode is explained in detail in FIG. 3A.

FIG. 3A illustrates an exemplary illustration of a method 300 for identifying one or more anomaly 108 on the road using the first mode, according to an embodiment. The method 300 is described in conjugation with FIG. 1 and FIG. 2 concurrently. Initially, a roadside computing device 306 that is representative of roadside computing device 110 and 210 in FIG. 1 and FIG. 2, respectively, wirelessly communicates with an end computing device 304, that is representative of end computing device 102 and 202 in FIG. 1 and FIG. 2, respectively, to start collecting the visual data. As such, the roadside computing device 110, 210, 306 commands the end computing device 102, 202, 304 to start collecting the visual data. In some embodiments, the end computing device 102, 202, 304 may start collecting the visual data (a) regardless of whether a command is received from the roadside computing device, (b) upon receiving a command from a user, or (c) when the end computing device is powered on. At this time, the processor 214 within the end computing device 102, 202, 304 commands a camera 302 associated with the end computing device 102, 202, 304 to start collecting the visual data when the vehicle 104 is travelling on the road 106. In an embodiment, the visual data is a live feed or a live stream video of the road 106. In an embodiment, the roadside computing device 110, 210, 306 may also set a minimum threshold speed of the vehicle 104, such as 20 kmph or 30 kmph, which when achieved by the vehicle 104, would automatically trigger the computing device 102, 202, 304 to start collecting the visual data. In another embodiment, the visual data may be collected independent of achievement of the speed of the vehicle 104 and depends on user initiating to start collecting the visual data using one or more buttons available on the graphical user interface, that is described in FIG. 4.

Furthermore, the visual data is simultaneously captured and transmitted to the processor 214 of the end computing device 102, 202, 304. A memory 216 of the end computing device 102, 202, 304 stores a machine learning (ML) model, such as a deep learning model that is pre-trained to detect and classify a road anomaly 108 in the visual data. In an example, the ML model is YOLOv8 or YOLOv8s that is trained by a RDD2022 dataset which contains 47420 images divided into 9035 test images without labels and 38385 training images with 55007 labels for 8 categories D00 for Longitudinal crack, D10 for Transverse crack, D20 for Alligator crack, D40 for Pothole, D43 for Crosswalk blur, D44 for White line blur, D50 for Manhole cover and repairs for one or more countries including Japan, India, Czech, Norway, United states and China with different image capturing devices such as smartphones, High-resolution cameras, Google street view images. To train the ML model, all images, videos, footages were split into 80:20 for training and validation respectively. A first model was trained on the pre-trained model YOLOv8s for 8 different classes. Only four classes were used to train all other models which are D00, D10, D20 and D40 and other classes were dropped. This part describes the data preprocessing part for training the ML model. Further, the ML models namely YOLOv8n and YOLOv8s for 8 classes D00, D10, D20, D40, D43, D44, D50 and repairs were trained offline with Pytorch environment using machine empowered with Intel core I9 13700K CPU at 5 GHZ, NVIDIA RTX3090Ti GPU and 64 GB RAM. All models were trained for 300 epochs, 16 batch size, 640 image size and 100 patience. Once trained, the ML model is used for detecting the one or more anomaly 108.

The road anomaly 108 includes a pothole, longitudinal cracks, transverse cracks, or alligator cracks on the road 106. As such, the processor 214 of the end computing device 102, 202, 304 fetches the machine learning model from the memory 216 and executes the pretrained ML model to identify presence of any pothole, longitudinal cracks, transverse cracks, or alligator cracks in the image. If, for example, a pothole is detected, the ML model classifies the anomaly 108 as the pothole type and increases a counter of the pothole. Similarly, if, for example, a longitudinal crack is detected, the ML model classifies the anomaly 108 as the longitudinal crack and increases a counter of the longitudinal crack. Similarly, the ML model classifies the anomaly 108 as transverse cracks or alligator cracks and increases the counter for transverse cracks and the counter for alligator cracks, respectively, when the visual data indicates presence of transverse cracks or alligator cracks, respectively.

Once, the ML model identifies the presence of one or more anomaly 108, the ML model automatically tags the image or footage having anomaly 108 with the GPS location of the vehicle and proceeds to identify one or more features of the identified anomaly 108. In an embodiment, the features include a size of the road anomaly 108. For example, the ML model tries to determine the size of the identified pothole or the identified longitudinal, transversal or alligator cracks, as, based upon the size of the anomaly 108, the ML model could identify the level of severity as either of a first type severity or a second type severity of the identified anomaly 108.

In order to identify the type of severity, the ML model in the processor 214, using the ML model identifies the size of the anomaly 108. To identify the size of the anomaly 108, the ML model in the processor 214 is trained to apply a bounding box over the identified anomaly 108 in the visual data and estimate the size of anomaly 108 based on dimensions of the smallest bounding box that encloses a portion of a frame of the visual data having the road anomaly 108. In other words, the ML model identifies the size of the bounding box covering the anomaly 108 in the visual data. This is illustrated with a simple example, as below:
In order to estimate the size of detected anomaly 108, the ML model finds the area (A) of the bounding box covering the anomaly 108 in terms of pixels used to display the anomaly 108, as below:

Area (A)=Length of the bounding box (L)*width of the bounding box (W).
=number of pixels in the length wise side of the bounding box*number of pixels in the widthwise side of the bounding box.

The memory 216 is further stored with a predefined threshold value (p) of the total number of pixels in the length wise side of the bounding box, as well as the total number of pixels in the width wise side of the bounding box. In an example, this value is based upon the size of the image of the visual data. More specifically,

If the image size=640*640 pixels,

Predefined threshold value (p)=10% of the image size=40960 pixels.

Now, in whichever visual data, if the size of the anomaly 108 in terms of number of pixels within the bounding box is above the predefined threshold value (ρ), the ML model marks the bounding box as of a first value which indicates detection of a large size anomaly 108 on the road 106. In other words, the ML model indicates the bounding box by a specific color, such as a red color, if the area or the percentage of the area of the frame or the image data of the bounding box exceeds the predefined threshold value (ρ). On the other side, in whichever visual data, if the size of the anomaly 108 in terms of number of pixels within the bounding box is below the predefined threshold value (ρ), the ML model immediately marks the bounding box as a second value which indicates detection of a small size anomaly 108 on the road 106. In other words, the ML model indicates the bounding box by another specific color, such as a green color, if the area or the percentage of the area of the frame or the image data of the bounding box does not exceed the predefined threshold value (ρ). Mathematically, the ML model uses the mathematical formulation as below:

$$if \{ \begin{matrix}A \geq ρ , large anomaly \\ Otherwise , small anomaly\end{matrix} \qquad ( 1 )$$

As such, the first value indicates a presence of more severe road anomaly 108 on the road 106, whereas the second value indicates a presence of less severe road anomaly 108 on the road 106. Thus, based upon the number of pixels being used for displaying the anomaly 108, the ML model marks the bounding box with either red color or green color along with the level of the severity as high or low, respectively. For example, high severity is indicated by red color bounding box, whereas less severity is indicated by green color bounding box. In this way, the ML model simultaneously identifies the severity level of the anomaly 108 based upon the size of the anomaly 108 (in terms of pixels) being used for displaying the anomaly 108 in the frame or the image.

The whole process of identifying the anomaly 108 and the severity level is described in a simple example. When the anomaly 108 is detected, the ML model identifies the total number of pixels being used for displaying the anomaly 108 within the area of bounding box of 409600 pixels. Now, the total number of pixels, for example, is 40000 pixels for displaying the anomaly 108, this number is less than the predefined threshold value (ρ) of 40960 pixels. At this time, the ML model identifies that the severity level is of second value as total number of pixels displaying the anomaly 108 is below the threshold value within the total area of the bounding box. The ML model thus displays the bounding box with green color and also displays, for example, a text associated with the bounding box as “Small pothole” or “Small alligator crack”. On the other side, suppose the anomaly 108 is detected by the ML model as a “longitudinal crack”. Now, the ML model identifies the total number of pixels being used for displaying the anomaly 108 within the area of bounding box of 409600 pixels. Now, the total number of pixels, for example, is 50000 pixels for displaying the anomaly 108, this number is quite higher than the predefined threshold value (ρ) of 40960 pixels. At this time, the ML model identifies that the severity level is of the first value as a total number of pixels displaying the anomaly 108 is above the threshold value within the total area of the bounding box. The ML model thus displays the bounding box with red color and also displays, for example, a text associated with the bounding box as “Large longitudinal crack”. Both types of severities are displayed in the GUI as shown in FIG. 4. A bounding box 404 shows the second value severity along with text as “Small alligator”, whereas a bounding box 404 shows a first value severity along with text as “Large alligator”. The detail of the GUI is explained later during description of FIG. 4.

Once the size of the road anomaly 108, and thus the level or type of severity related to anomaly 108 is identified in the visual data, the end computing device 102, 202, 304 sends a first signal to a roadside computing device 110, 210, 306 installed on the road 106 to transmit an anomaly specific notification to multiple end computing devices installed over the other vehicle 308 in the proximity of the roadside computing device 110, 210, 306. At this time, end computing device 102, 202, 304 streams portions of the visual data containing the detected road anomaly 108 to the roadside computing device 110, 210, 306. In other words, the end computing device 102, 202, 304 only streams those frames of the visual data which contains the anomaly 108.

After receiving the portions of the frames, the roadside computing device 110, 210, 306 prepares a file as a road anomaly 108 data and stores the road anomaly 108 data received from the end computing device 102, 202, 304 in an electronic storage device, such as in the memory 206 of the roadside computing device 110, 210, 306. The road anomaly 108 data may include an image of the road anomaly 108, a type of the road anomaly 108, a location of the road anomaly 108, or a severity of the road anomaly 108. For example, the roadside computing device 110, 210, 306 stores the following data as below:
Image of anomaly 108
Type=“pothole”
Location=28° 38′ 41.2800″ N and 77° 13′ 0.1956″ E
Severity=First type.

In another example, when the anomaly 108 detected is alligator type crack, the roadside computing device 110, 210, 306 stores the following data as below:
Image of anomaly 108
Type=“Alligator Crack”
Location=40° 41′ 49.2812″ N and 79° 11′ 0.3456″ E
Severity=Second type.

Once the roadside computing device 110, 210, 306 prepares the file of the road anomaly 108 data, the roadside computing device 110, 210, 306 transmits a notification to other multiple end computing devices installed over the other vehicle 308 that are currently available on the road 106 in the proximity of the roadside computing device 110. The notification may include the road anomaly 108 data. In an embodiment, the notification is an anomaly 108-specific notification. For example, when a pothole type anomaly 108 is detected, the notification may flash a message as “Pothole Anomaly” or “Alligator crack Anomaly”. In an embodiment, the notification, or the road anomaly 108 data includes a warning notification such as, “Alert! An anomaly is detected. The anomaly is pothole.”. In another example, the warning notification may include “Alert! An anomaly is detected. The anomaly is Longitudinal crack.”. Furthermore, the notification or the road anomaly 108 data additionally include an image of the road anomaly 108, a location of the road anomaly 108, or a severity of the road anomaly 108, for example “second type pothole”. In an embodiment, the warning notification could be a sound, light, or vibration-based notification. For example, a stereo or a music player, a flashlight or a vibration-based steering wheel, connected with the end computing device 102, 202, 304 may play the warning notification, flash a series of light, vibrate the steering wheel, simultaneously, to attract the attention of occupants of the other vehicle 308 after it is detected by the ML module.

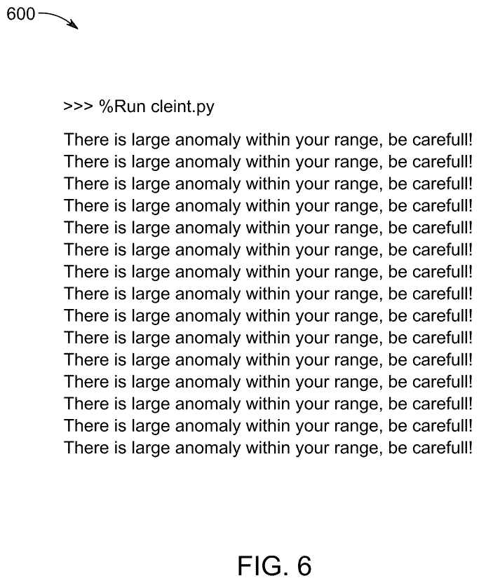

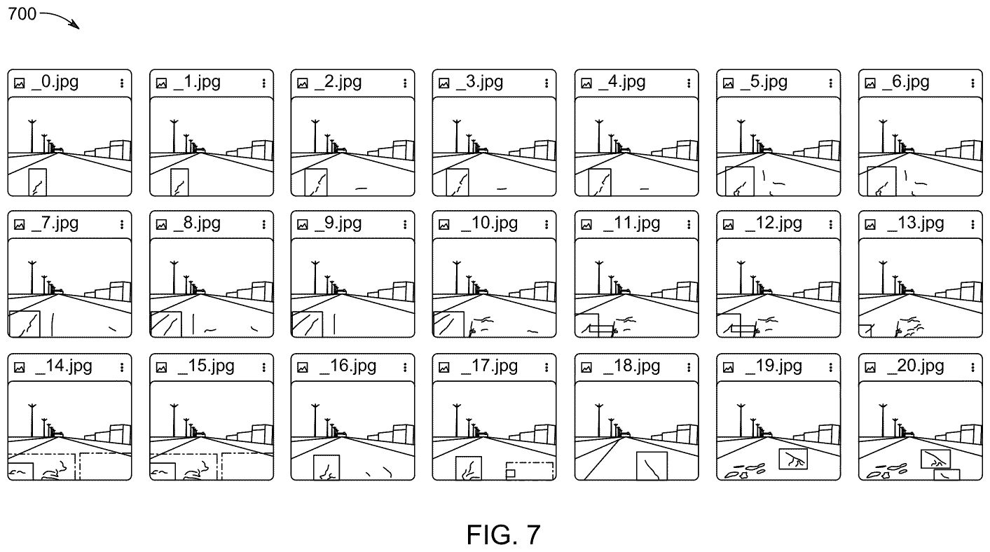

In an embodiment, the warning notification could be provided on the number of the cellphone user of a vehicle owner travelling by the other vehicle 308 on the road 106. For example, the roadside computing device 110, 210, 306 may fetch, social media account, current WhatsApp status, WhatsApp location, Facebook account, twitter account, Instagram account, or alike, associated with the number of the cellphone to identify if the other vehicle 308 is traveling on the road 106. If the roadside computing device 110, 210, 306 identifies that the number of cellphone users appears to be traveling on the road 106 with the other vehicle 308 having anomalies 108 on the road 106, the roadside computing device 110, 210, 306 concludes that the user of the cellphone is traveling on the road 106 and thus transmits the warning notification to the number associated with the cellphone. In another embodiment, the warning notification could be provided based upon the GPS location of the other vehicle 308. For example, the roadside computing device 110, 210, 306 may also be configured to fetch the GPS location of all vehicles currently travelling or planning to travel on the road 106. Based upon the GPS location of the other vehicle 308, the roadside computing device 110, 210, 306 may provide the warning notification (e.g., when the vehicle is in the proximity of the identified anomaly). The transmission of the notification could be done via V2X communication technique, IoT or Wi-Fi using client server-based approach. The warning notification is explained later in FIG. 6. In an embodiment, the stored road anomaly 108 data is also transmitted to a road maintenance authority 312 via the cloud server 310 which is explained in detail in FIG. 7.

Referring back to FIG. 1, FIG. 2, and FIG. 3, in an embodiment, the end computing device 102, 202, 304 transmits the road anomaly 108 data to the roadside computing device 110, 210, 306 when severity of only first value (e.g., high severity) is detected. In this case, the transmission of the notification is based on the severity of the road anomaly 108 matching a specified criterion. For example, the end computing device 102, 202, 304 identifies that the anomaly 108 corresponding to the first value is detected. The end computing device 102, 202, 304 identifies that the anomaly 108 corresponding to the first value matches with the specified criteria of first value-based anomaly 108. In this case, the end computing device 102, 202, 304 concludes that the notification should be broadcasted to other nearby multiple end computing devices installed over the other vehicle 308. This means, when a highly damaged or anomaly 108 is detected, the end computing device 102, 202, 304 communicates the notification to the roadside computing device 110, 210, 306 so that the roadside computing device 110, 210, 306 transmits the notification to other multiple end computing devices installed over the other vehicle 308 that are currently available on the road 106 in the proximity of the roadside computing device 110 so that other vehicles 308 that are currently traveling in time are alerted before they reach to the point of anomaly 108.

In another embodiment, the end computing device 102, 202, 304 transmits the road anomaly 108 data to the roadside computing device 110, 210, 306 when severity of the first value is detected even after detecting another anomaly 108 corresponding to the severity of second value is detected. This means that a high severe anomaly 108 is detected after detecting a less severe anomaly 108. In this case, the end computing device 102, 202, 304 identifies that the anomaly 108 corresponding to the first value matches with the specified criteria of the first value-based anomaly 108 even if it is detected after detecting the second value-based anomaly 108. In this case, the end computing device 102, 202, 304 concludes that the notification should be broadcasted to other nearby multiple end computing devices installed over the other vehicle 308. This means, when a highly damaged or anomaly 108 is detected, even if the highly damaged anomaly 108 is detected after detecting a less severe anomaly 108, the end computing device 102, 202, 304 immediately transmits the notification to the roadside computing device 110, 210, 306 so that the roadside computing device 110, 210, 306 transmits the notification to other multiple end computing devices installed over the other vehicle 308 that are currently available on the road 106 in the proximity of the roadside computing device 110 so that the vehicles 308 are alerted before they reach to the point of anomaly 108.

In another embodiment, regardless of the severity level of the anomaly 108, the roadside computing device 110, 210, 306 transmits the road anomaly 108 data whenever it is detected. This means, even if second value severity of an anomaly 108 is detected and not the first value severity, the road anomaly 108 data is transmitted to other multiple end computing devices installed over the other vehicle 308. In all such cases, the road anomaly 108 data is also transmitted to the cloud server 310 so that the road maintenance authority 312 could analyze the condition of the road 106 and initiate the road repair maintenance in efficient manner.

Apart from identifying the image of the anomaly 108, type of the anomaly 108, location of the anomaly 108, severity of the anomaly 108, the end computing device 102, 202, 304 is also configured to identify the total count value of the number of identified anomalies 108. For example, in any specific road where the vehicle 104 is travelling, there is a possibility that the number of anomalies 108 are high in number in a sequence of the frame of the visual data i.e., in each frame. As such, the end computing device 102, 202, 304 is also configured to count the total number of anomalies 108 in each frame of the visual data. As discussed earlier, the end computing device 102, 202, 304 simultaneously increases the counter value of each type of the anomaly 108 as soon as it is detected. For example, if the sequence of frame i.e., in the first frame, if the “Pothole” type anomaly 108 is identified and in the second frame, “Alligator crack” type anomaly 108 is detected, the end computing device 102, 202, 304 increases the counter related to “Pothole” and “Alligator crack” simultaneously. However, there is a possibility that the same anomaly 108 is counted several times in different frames. In this case, the total number of counts would become misleading. For example, when the vehicle 104 is moving, the camera takes an image of the road where one pothole is detected when the vehicle 104 is at a certain distance from the location of the pothole. However, in the next frame when the vehicle is close to the pothole, the camera may again take image which may show the same anomaly 108 that is already identified in the previous frame or visual data. In simple words, when the vehicle is moving at high speed, each frame spans a large space and hence the camera 302 of the end computing devices 102, 202, 304 might observe multiple anomalies. In contrary, when the vehicle is moving at low speed, each frame spans a small space and hence the camera of the end computing devices 102, 202, 304 might observe the same anomaly 108 over multiple frames. In both cases, a misleading count would be generated. To avoid this misleading count, the ML module may implement a technique to skip few frames which eliminates generation of redundant images of same anomaly 108 in another sequential frame such that the end computing device 102 202, 304 counts the detected anomaly 108 only once. This approach is implemented as a frame span interval (FSI) approach.

In FSI approach, the ML model initially identifies the speed of the vehicle 104. The measurement of the speed could be identified by a speed sensor (not shown) of the vehicle 104. For example, the end computing device 102, 202, 304 could be connected, wired or wirelessly, with the speed sensor of the vehicle 104 to identify the current speed of the vehicle 104. On the other side, ML model is also configured to identify settings of the camera connected with the end computing device 102, 202, 304. Based upon the two values, the ML model computes the FSI as below:

FSI=Vehicle speed (m/s)/FPS (frame/sec) m/frame

Now, the ML model is pre-set to skip 5 frames if the FSI comes out to be greater than 0.5. Otherwise, the ML model is pre-set to skip 30 frames if the FSI comes out to be less than 0.5 Mathematically,

$$if \{ \begin{matrix}FSI \geq 0.5 , skip 5 frames \\ Otherwise , skip 30 frames\end{matrix} \qquad ( 2 )$$

Based upon equation (2), the ML model determines a specified number of frames to be skipped from multiple frames of the visual data. Here, the ML model has a preset threshold value of the FSI=0.5. As such, the specified number of frames to be skipped when the computed value of the FSI is greater than at the specified threshold of 0.5 which is lesser than the specified number of frames to be skipped when the computed value of the FSI is lesser than the specified threshold of 0.5. For example, at the speed of 20 km/h, the ML model skips 30 frames at a specific value of frames per second of the camera. On the other side, for the speed of 60 km/h, the ML model skips 5 frames at the specific value of frames per second of the camera. In both cases, it was experimentally observed that the ML model misses less number of anomaly 108 and generates very less number of duplicates of the anomaly 108. As such, the ML model selects the 6th frame and skips initial 5 frames if the FSI=>0.5. On the other side, the ML model selects the 31th frame and skips initial 30 frames if the FSI<0.5. Accordingly, based upon the FSI, the end computing device 102, 202, 304 counts the total number of anomalies 108 on the specific road 106 and simultaneously increases the counter for each type of the anomaly 108.

The anomalies captured by the end computing device 102, 202, 304 is also stored in the memory 216, with a specified threshold count value for a specific length of the road 106. For example, for 1 km length of the road, the threshold count value could be set as 30 anomalies 108. If, the total count value of the number of anomalies 108 is above 30 counts, the ML model identifies that the number of anomalies 108 are quite high in number for the specific location of the specific length of the road 106. At this time, the end computing device 102, 202, 304 sends a second signal to the roadside computing device 110, 210, 306 to transmit a general notification to the other end computing devices installed over the other vehicle 308 in the proximity of the roadside computing device 110. The general notification indicates a presence of multiple road anomalies 108 in the proximity of the other end computing devices 102. The general notification may additionally include the images, location, severity of the anomaly 108.

FIG. 3B illustrates an exemplary illustration of the method 314 for identifying one or more anomaly 108 on the road using the second mode, according to an embodiment. The method is again described in conjugation with FIGS. 1 and 2 concurrently. Initially, a roadside computing device 306 that is representative of roadside computing devices 110 and 210 in FIGS. 1 and 2, respectively, wirelessly communicates with an end computing device 304, that is representative of end computing device 102 and 202 in FIGS. 1 and 2, respectively, to start collecting the visual data. As such, the roadside computing device 110, 210, 306 commands the end computing device 102, 202, 304 to start collecting the visual data. At this time, the processor 214 within the end computing device 102, 202, 304 commands a camera 302 associated with the end computing device 102, 202, 304 to start collecting the visual data when the vehicle 104 is travelling on a road 106.

Now, the end computing device 102, 202, 304 simultaneously captures and tags each visual data with the GPS location of the vehicle and transmits to the processor 204 of the roadside computing device 110, 210, 306. In an embodiment, the transmission of all visual data is accomplished by using a user datagram protocol (UDP). The memory 206 of the roadside computing device 110, 210, 306 also stores a machine learning (ML) model, such as the pre-trained deep learning model that is pre-trained to detect and classify a road anomaly 108 such as the pothole, longitudinal cracks, transverse cracks, or alligator cracks preset in the visual data. As such, the processor 204 of the roadside computing device 110, 210, 306 fetches the machine learning model from the memory 206 and executes the ML model to identify presence of any pothole, longitudinal cracks, transverse cracks, or alligator cracks in the image or video stream. Detection of one or more anomaly 108 using the ML model is described in detail as in FIG. 3A and is not repeated herein.

Once, the ML model in the processor 204 identifies the presence of one or more anomaly 108, the ML model automatically proceeds to identify one or more feature of the identified anomaly 108. In an embodiment, the features includes the size of the road anomaly 108. As described earlier, the ML model identifies the size of the identified pothole or the identified longitudinal, transversal or alligator cracks. Also, the ML model identifies the level of severity as either of a first type severity or a second type severity of the identified anomaly 108. In order to identify the type of severity, the ML model in the processor 206 is also trained to identify the size of the anomaly 108 using the same principle of bounding box as described in FIG. 3A. For example, the processor 206 applies a bounding box over the identified anomaly 108 in the visual data and estimate the size of the anomaly 108 based-on dimensions of the smallest bounding box that encloses a portion of a frame of the visual data having the road anomaly 108. Detection of size of one or more anomaly 108 by the ML model using the bounding box is described in detail as in FIG. 3A and is not repeated herein.

The ML model, after identifying the size of the bounding box, thus displays the bounding box with, for example, green color when second value anomaly 108 is detected, and with, for example, Red color when first value anomaly 108 is detected. As described earlier while describing FIG. 3A, both types of severity is displayed in the GUI as shown in FIG. 4. The bounding box 404 shows the second value severity along with text as “Small alligator”, whereas the bounding box 404 shows a first value severity along with text as “Large alligator”. The detail of the GUI is explained later during description of FIG. 4.

Once the size of the road anomaly 108 and thus the level or type of severity related to anomaly 108 is identified in the visual data, the roadside computing device 110, 210, 306 prepares a file as a road anomaly 108 data and stores the road anomaly 108 data in an electronic storage device, such as in the memory 206 of the roadside computing device 110, 210, 306. The road anomaly 108 data may include an image of the road anomaly 108, a type of the road anomaly 108, a location of the road anomaly 108, or a severity of the road anomaly 108. For example, the roadside computing devices 110, 210, 306 stores the following data as below:
Image of anomaly 108
Type=“pothole”
Location=28° 38′ 41.2800″ N and 77° 13′ 0.1956″ E
Severity=First type.
   Once the roadside computing device 110, 210, 306 prepares the file of the road anomaly 108 data, the roadside computing device 110, 210, 306 transmits a notification to multiple end computing devices installed over the other vehicle 308 that are currently available on the road 106 in the proximity of the roadside computing device 110. Transmission of notification regarding the anomaly 108 is described in detail as in FIG. 3A and is not repeated herein. In an embodiment, the stored road anomaly 108 data is also transmitted to a road maintenance authority 312 via the cloud server 310. This is also explained in FIG. 7.

Referring back to FIG. 1, FIG. 2, and FIG. 3, in an embodiment, the roadside computing device 110, 210, 306 transmits the road anomaly 108 data when severity of only first value is detected. In this case, the transmission of the notification is based on the severity of the road anomaly 108 matching a specified criterion. For example, the roadside computing device 110, 210, 306 identifies that the anomaly 108 corresponding to the first value is detected. The roadside computing device 110, 210, 306 identifies that the anomaly 108 corresponding to the first value matches with the specified criteria of first value-based anomaly 108. In this case, the roadside computing device 110, 210, 306 concludes that the notification should be broadcasted to nearby other multiple end computing devices installed over the other vehicle 308. This means, when a highly damaged or anomaly 108 is detected, the roadside computing device 110, 210, 306 immediately transmits the notification to other multiple end computing devices installed over the other vehicle 308 that are currently available on the road 106 in the proximity of the roadside computing device 110 so that other vehicles 308 that are currently traveling in time are alerted before they reach to the point of anomaly 108.

In another embodiment, the roadside computing device 110, 210, 306 transmits the road anomaly 108 data when severity of the first value is detected even after detecting another anomaly 108 corresponding to the severity of second value is detected. This means that a high severe anomaly 108 is detected after detecting a less severe anomaly 108. In this case, the roadside computing device 110, 210, 306 identifies that the anomaly 108 corresponding to the first value matches with the specified criteria of the first value-based anomaly 108 even if it is detected after detecting the second value-based anomaly 108. In this case, the roadside computing device 110, 210, 306 concludes that the notification should be broadcasted to other nearby other multiple end computing devices installed over the other vehicle 308. This means, when a highly damaged or anomaly 108 is detected, even if the highly damaged anomaly 108 is detected after detecting a less severe anomaly 108, the roadside computing device 110, 210, 306 immediately transmits the notification to other multiple-end computing devices installed over the other vehicle 308 that are currently available on the road 106 in the proximity of the roadside computing device 110 so that other vehicles 308 that are currently traveling in time are alerted before they reach to the point of anomaly 108.

In another embodiment, regardless of the severity level of the anomaly 108, the roadside computing device 110, 210, 306 transmits the road anomaly 108 data whenever it is detected. This means, even if second value severity of an anomaly 108 is detected and not the first value severity, the road anomaly 108 data is transmitted to other multiple end computing devices installed over the other vehicle 308. In both cases, the road anomaly 108 data is also transmitted to the cloud server 310 so that the road maintenance authority 312 could analyze the condition of the road 106 and initiate the road repair maintenance in efficient manner.

The roadside computing device 110, 210, 306 is further configured to use the FSI approach to count the number of anomalies in subsequent frames or footage. Counting the anomaly 108 by the ML model is described in detail as in FIG. 3A and is not repeated herein. Furthermore, if, the total count value of the number of anomalies 108 is above 30 counts, for example, the ML model identifies that the number of anomalies 108 are quite high in number for the specific location of the specific length of the road 106. At this time, the end computing device 102, 202, 304 sends a general notification to the other end computing devices installed over the other vehicle 308 in the proximity of the roadside computing device 110. The general notification indicates the presence of multiple road anomalies 108 in the proximity of the other end computing devices 102.

In another embodiment, the roadside computing device 110, 210, 306, in either mode I or II, is also configured to obtain a route data from other or a first end computing device installed over the other vehicle 308. The route data is indicative of a route to be travelled by the other vehicle 308. The route data may be obtained by the planning data of the other vehicle 308. The planning data may be a GPS data of the other vehicle 308 which indicates a future location of the other vehicle 308 over the road 106. The route data may also be accessed through the user Facebook profile, Whatsapp status, twitter account, Gmail account, or any social media account. In an embodiment, a user searching for a specific road information on a Google map in between a source and destination location may be accessed by the roadside computing device 110, 210, 306 using internet, IoT technique etc. At this time, the roadside computing device 110, 210, 306 is configured to compare the route data with road anomaly 108 data stored in the memory 206 of the roadside computing device 110, 210, 306 to determine a set of road anomalies 108 along the route of the vehicle planning to travel on the mentioned route. Therefore, the roadside computing device 110, 210, 306 is further configured to transmit information regarding the set of road anomalies 108 to another first end computing device installed over the other vehicle 308, that the occupants of the vehicle in which another first end computing device installed over the other vehicle 308 is installed are aware beforehand.

In another embodiment, the end computing device 102, 202, 304 in mode I or the roadside computing device 110, 210, 306 in mode II, is also configured to determine features that includes determining a depth of the road anomaly 108. For example, the system may use various images or video streams taken in the past, to train the ML model to identify to determine the depth of the anomaly 108, such as the depth of the pothole, longitudinal cracks, transverse cracks, or alligator cracks on the road 106. In some embodiments, the depth data may also be used in addition to, or instead of, the size of the anomaly 108 to determine the severity of the anomaly 108. Once the ML model in end computing device 102, 202, 304 in mode I or the ML model in the roadside computing device 110, 210, 306 in mode II, determines the depth of the anomaly 108, the roadside computing device 110, 210, 306 is also configured to transmit the alert notification to the nearby other vehicles 308 regarding the depth of the anomaly 108. The process of transmission of the alert notification is already described earlier, and is not repeated herein.

With reference to all FIGS. 1-3, all methods or system of detecting road anomaly 108 is described by assuming manual selection of modes by manually pressing the option of selecting the modes over the graphical user interface that is represented in FIG. 4. In an embodiment, the system and method described in aforementioned FIGS. 1-3 could be operated in terms of automatic selection of modes. For example, when mode I is selected and the end computing device 102, 202, 304 captures and processes the visual data. The end computing device 102, 202, 304 only transmits those images which contains the anomaly 108. At this time, the roadside computing device 110, 210, 306 does not use the ML module stored in the memory 206 of the roadside computing device 110, 210, 306. However, there may occur a case when the end computing device 102, 202, 304 identifies an overburden of processing lots of visual data, or the processor 214 of the end computing device 102, 202, 304 takes longer time the expected to process the visual data, or the RAM of the end computing device 102, 202, 304 does not have sufficient memory or storage to process all visual data in the prescribed time when Mode I is selected. In such cases, the end computing device 102, 202, 304 may request the roadside computing device 110, 210, 306 to process some or all the visual data. In this case, the roadside computing device 110, 210, 306 may automatically switch the Mode I to Mode II and start processing the requested visual data in the processor 204 of the roadside computing device 110, 210, 306 to identify the anomaly 108 in the visual data captured by the end computing device 102, 202, 304 to relief the burden from the end computing device 102, 202, 304. When the end computing device 102, 202, 304 determines an availability of sufficient storage or memory to again process all visual data, the end computing device 102, 202, 304 may request the roadside computing device 110, 210, 306 to handover processing of all visual data. In this case, roadside computing device 110, 210, 306 may switch Mode II back to Mode I and provide full access to the end computing device 102, 202, 304 to process all visual data in the processor 214 of the end computing device 102, 202, 304 to identify the road anomaly 108. In this way, mode selection could be switched back and forth in between Mode I and Mode II automatically.

FIG. 4 illustrates a video footage 400 displayed on the roadside computing device 110, 210, 306, according to an embodiment. The video footage includes a graphic user interface 402. The graphic user interface 402 includes a small bounding box 404 that shows the severity of the anomaly 108. For example, when end computing device 102, 202, 304 identifies a second value anomaly 108, i.e., less severe anomaly 108, the graphic user interface 402 displays the anomaly 108 in a green color bounding box so that the user of the graphic user interface 402 or the roadside computing device 110, 210, 306 after it connected with the portable device such as laptop, cellphone, etc. could clearly see and analyze a less saver anomaly 108. On the other hand, when end computing device 102, 202, 304 identifies a first value anomaly 108, i.e., more severe anomaly 108, the graphic user interface 402 displays the anomaly 108 in, for example, a red color bounding box.

The graphic user interface 402 further includes a user option tab 406. The user option tab 406 includes one or more options to execute by the end computing device 102, 202, 304. For example, if the user clicks on “Run object detection”, the roadside computing device 110, 210, 306 commands the end computing device 102, 202, 304 to start detection of the anomaly 108. If the user clicks on “Stop detection”, the roadside computing device 110, 210, 306 commands the end computing device 102, 202, 304 to stop anomaly 108 detection. If the user clicks on “Select video”, the roadside computing device 110, 210, 306 provides an option to the user to upload any video or footage of a road 106 to identify the presence of one or more anomaly 108 by the running the ML module on end computing device 102, 202, 304 itself. By clicking on “Mode 1”, the end computing device 102, 202, 304 commands the end computing device 102, 202, 304 to start detection of the anomaly 108 where anomaly 108 detection is performed at the end computing device 102, 202, 304 only and the end computing device 102, 202, 304 transmits only portion of the frames which include the presence of the one or more anomaly 108. By clicking on “Mode 2”, the end computing device 102, 202, 304 commands the end computing device 102, 202, 304 to start capturing the visual data and send all visual data to the roadside computing device 110, 210, 306 where the detection of the anomaly 108 is performed at the roadside computing device 110, 210, 306. The video footage 400 further includes an anomaly count tab 408. The anomaly count tab 408 shows a category or classification of the identified anomaly 108 detected by either the end computing device 102, 202, 304 or the roadside computing device 110, 210, 306. On successive detection of the anomaly 108, the anomaly count tab increases the count of the respective anomaly 108 i.e., pothole, transverse crack, longitudinal crack, alligator crack etc. In an embodiment, to enhance the process time and correctly count the anomalies, the graphic user interface 402 may include a text field to control the frame skipping functionality.

FIG. 5 illustrates an exemplary video footage 500 at plurality of location of roads 106, according to an embodiment. The video footage 500 includes a graphic user interface 502. In each case, it is clearly visible in the graphic user interface 502 that the ML module is efficiently able to identify the anomaly 108 even if the anomaly 108 is a pothole, longitudinal cracks, transverse cracks, or alligator cracks on the road 106 and even if the ML module is implemented at either the end computing device 102, 202, 304 or the roadside computing device 110, 210, 306. The bounding box 504 turns either red color or green color depending upon the severity of the anomaly 108.

FIG. 6 illustrates an exemplary warning notification 600, according to an embodiment. The warning notification 600 could be provided in the form of text, mail, instant message or email along with the image, location, severity of the anomaly.

FIG. 7 illustrates a storage environment 700 on the cloud server to store the road anomaly data, according to an embodiment. The stored road anomaly data by the roadside computing device 110, 210, 306 is also transmitted to the storage environment 700 of the cloud server 310. In an embodiment, the storage environment 700 represents a Google Drive. In an embodiment, the road anomaly data may be transmitted to the cloud server 310 immediately when it is detected. In another embodiment, the road anomaly data may be transmitted to the cloud server 310 after a predetermined time interval. For example, the predetermined time interval could be a 1 hour, 10 hours, or 24 hours, weekly or monthly basis. From the cloud server 310, stored road anomaly data may be provided or accessed by a road maintenance authority 312 in order to initiate road repair maintenance in a timely manner.

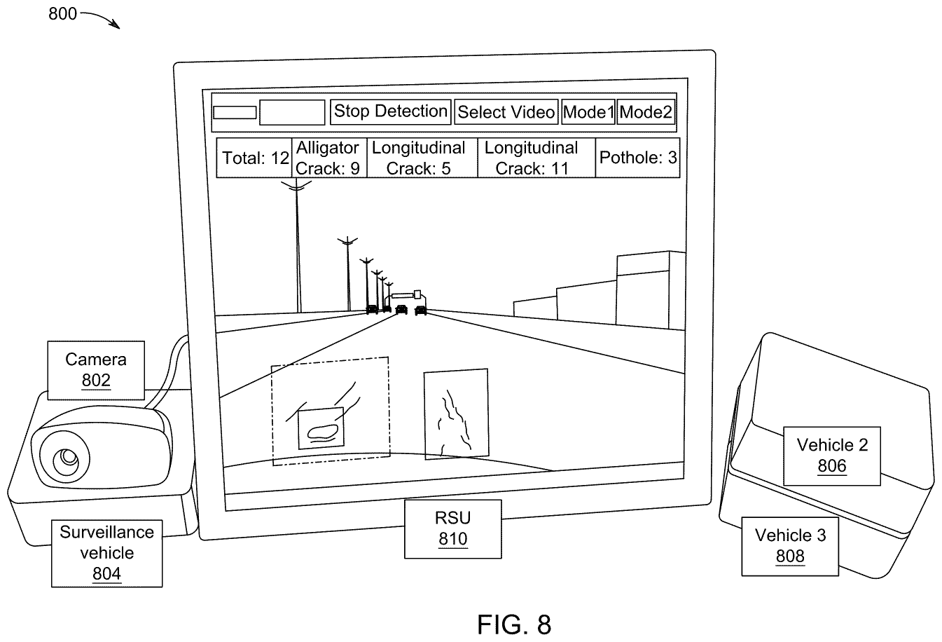

FIG. 8 illustrates an exemplary prototype of an anomaly detection system 800, according to an embodiment. The anomaly detection system 800 includes an end computing device 802 that is illustrative of the end computing device 102, 202, 304 in FIG. 1, FIG. 2, FIG. 3. The end computing device 802 may include a Raspberry pi 4 8 GB processor. However, any other advance processor known in the current art may be used. The anomaly detection system 800 further includes a roadside computing device 810 that is illustrative of the roadside computing device 110, 210, 306 in FIG. 1, FIG. 2, FIG. 3. The roadside computing device 810 may include a Microsoft Surface pro 6 hardware with i5-8250U GPU and 8 GB RAM. Any other advance hardware, laptop, desktop known in the current art may be used for this purpose. The anomaly detection system 800 further includes a vehicle 804 that is representative of the vehicle 104 in FIG. 1, FIG. 2 and FIG. 3. The anomaly detection system 800 further includes one or more other vehicle 806 and 808 that is representative of the other vehicle 308 in FIGS. 3A and 3B. The anomaly detection system 800 further includes a camera that is an integral part of the end computing device 802 installed over the vehicle 104, 804. The camera could be a Logitech C310 camera.

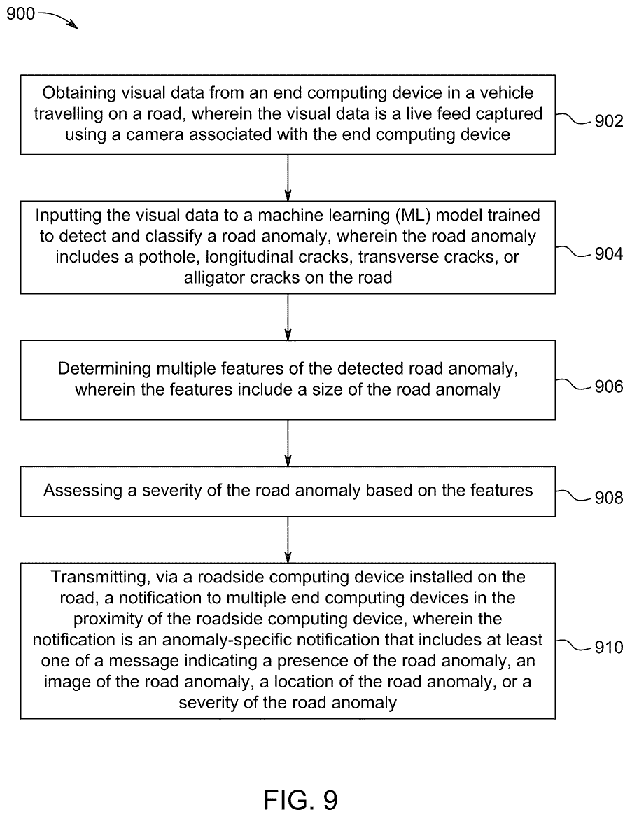

FIG. 9 illustrates a flowchart of a method 900 of detecting road anomalies 108, according to an embodiment. The method 900 is described in conjunction with FIG. 1-FIG. 8. Various steps of the method 900 are included through blocks in FIG. 9. One or more blocks may be combined or eliminated to achieve the objective of method of detecting road anomalies 108 without departing from the scope of the present disclosure.

At step 902, the method 900 includes obtaining visual data from an end computing device 102, 202, 304 in a vehicle 104 travelling on a road 106. The visual data is a live feed captured using a camera associated with the end computing device 102, 202, 304.

At step 904, the method 900 further includes inputting the visual data to an ML model trained to detect and classify a road anomaly 108. The road anomaly 108 includes a pothole, longitudinal cracks, transverse cracks, or alligator cracks on the road. The ML model may be implemented in the processor 214 of the end computing device 102, 202, 304. In another embodiment, the ML model may be implemented in the processor 204 of the roadside computing device 110, 210, 306 installed on the road 106.

At step 906, the method 900 further includes determining multiple features of the detected road anomaly 108. The features include a size of the road anomaly 108.

At step 908, the method 900 further includes assessing a severity of the road anomaly 108 based on features. The severity of the road anomaly 108 may be determined in a number of ways. For example, the severity may be determined based on the feature such as a size of the anomaly 108.

At step 910, the method 900 further includes transmitting, via a roadside computing device 110, 210, 306 installed on the road 106, a notification to multiple end computing devices in the proximity of the roadside computing device 110, 210, 306. The notification is an anomaly-specific notification that includes at least one of a message indicating a presence of the road anomaly 108, an image of the road anomaly 108, a location of the road anomaly 108, or a severity of the road anomaly 108.

Based upon FIGS. 1, 2, 3A, 3B, 4, 5, 6, 7 and 8, the invention further includes a non-transitory computer-readable storage medium for storing computer-readable instructions that, when executed by a computer, cause the computer to perform a method of detecting road anomaly 108. The method may be implemented as the non-transitory computer-readable storage medium and stored in the memory 216 of the end computing device 102, 202, 304. In an embodiment, the method may also be implemented as the non-transitory computer-readable storage medium and stored in the memory 206 of the roadside computing device 110, 210, 306.

The method includes generating, obtaining visual data from an end computing device 102, 202, 304 installed in a vehicle 104 travelling on a road 106. The visual data is a live feed captured using a camera associated with the end computing device 102, 202, 304.

The method further includes generating, inputting the visual data to a machine learning (ML) model trained to detect and classify a road anomaly 108. The road anomaly 108 includes a pothole, longitudinal cracks, transverse cracks, or alligator cracks on the road. The machine learning model is stored in the memory 216 of the end computing device 102, 202, 304 to detect and classify a road anomaly 108 in a first mode. Additionally, the machine learning model is stored in the memory 206 of the roadside computing device 110, 210, 306 to detect and classify a road anomaly 108 in a second mode.

The method further includes determining multiple features of the detected road anomaly 108. The features include a size of the road anomaly 108.

The method further includes assessing a severity of the road anomaly 108 based on the features.

The method further includes sending a first signal to a roadside computing device 110, 210, 306 installed on the road 106 to transmit an anomaly specific notification to multiple end computing devices in the proximity of the roadside computing device 110, 210, 306. The anomaly specific notification includes at least one of a message indicating a presence of the road anomaly 108, an image of the road anomaly 108, a location of the road anomaly 108, or a severity of the road anomaly 108. The multiple end computing device is installed over the other vehicle 308.

The non-transitory computer-readable storage medium for storing computer-readable instructions for executing the method for detecting the anomaly 108, where the severity is determined based on the size of the road anomaly 108. The size is determined based on dimensions of a smallest bounding box that encloses a portion of a frame of the visual data having the road anomaly 108.

The non-transitory computer-readable storage medium for storing computer-readable instructions for executing the method for detecting the anomaly 108, where the severity is determined to be of a first value when an area of the bounding box exceeds a specified threshold area, and a second value when the area does not exceed the specified threshold area. The first value is indicative of a more severe road anomaly 108 than the second value. The specified threshold area is determined as a percentage of an area of the frame.

The method further includes determining a count of road anomalies 108 detected in the visual data based on a frame span interval (FSI) metric.

The method of determining the count further includes determining the FSI based on frames per second of the camera and speed of the vehicle, determining a specified number of frames to be skipped from multiple frames of the visual data based on the FSI, and selecting a next frame of the sequence for detecting the road anomaly 108 based on the specified number of frames to be skipped.

The non-transitory computer-readable storage medium for storing computer-readable instructions for executing the method for detecting the anomaly 108, where the specified number of frames to be skipped when the FSI is greater than a specified threshold is lesser than the specified number of frames to be skipped when the FSI is lesser than the specified threshold.

The method further includes determining that the count of road anomalies 108 exceeds a specified threshold, and sending a second signal to the roadside computing device 110, 210, 306 to transmit a general notification to the end computing devices installed over the other vehicle 308 in the proximity of the roadside computing device 110, 210, 306. The general notification is indicative of a presence of multiple road anomalies 108 in the proximity of the end computing devices 110, 210, 306.

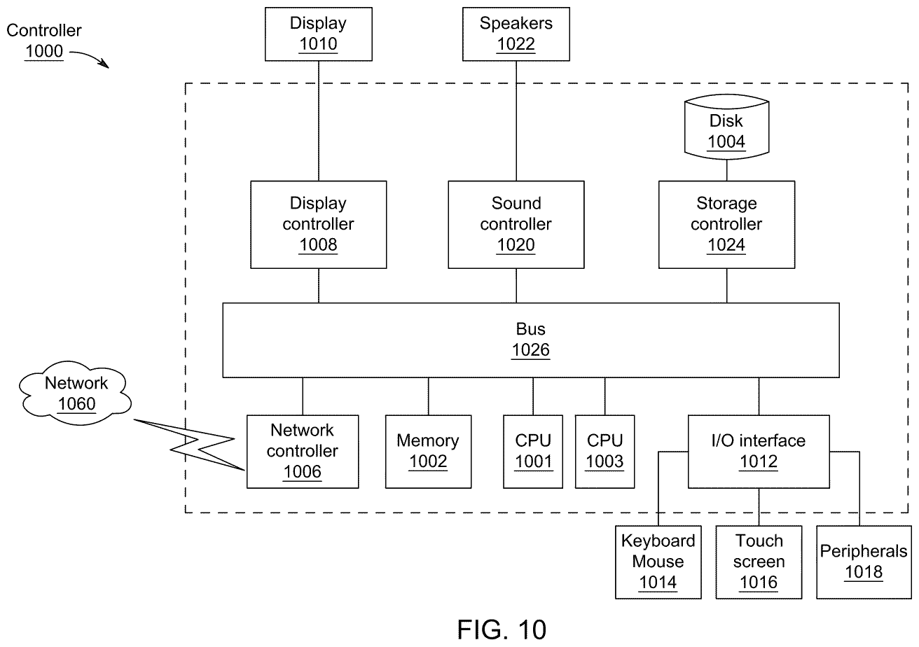

Next, further details of the hardware description of the computing environment according to exemplary embodiments is described with reference to FIG. 10. In FIG. 10, a controller 1000 described is representative of the end computing device 102, 202, 304 configured for detecting road anomalies during mode I as illustrated in FIG. 1. In another embodiment, the controller 1000 described is representative of the roadside computing device 110, 210, 360 configured for detecting road anomalies during mode II as illustrated in FIG. 1. In either case, the controller 1000 is a computing device which includes a CPU 1001 which performs the processes described above/below. The process data and instructions may be stored in memory 1002. These processes and instructions may also be stored on a storage medium disk 1004 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1001, 1003 and an operating system such as Microsoft Windows 7, Microsoft Windows 10, Microsoft Windows 11, UNIX, Solaris, LINUX, Apple MAC-OS, and other systems known to those skilled in the art.

The hardware elements in order to achieve the computing device may be realized by various circuitry elements, known to those skilled in the art. For example, CPU 1001 or CPU 1003 may be a Xenon or Core processor from Intel of America or an Opteron processor from AMD of America, or may be other processor types that would be recognized by one of ordinary skill in the art. Alternatively, the CPU 1001, 703 may be implemented on an FPGA, ASIC, PLD or using discrete logic circuits, as one of ordinary skill in the art would recognize. Further, CPU 1001, 703 may be implemented as multiple processors cooperatively working in parallel to perform the instructions of the inventive processes described above.

The computing device in FIG. 10 also includes a network controller 1006, such as an Intel Ethernet PRO network interface card from Intel Corporation of America, for interfacing with network 1060. As can be appreciated, the network 1060 can be a public network, such as the Internet, or a private network such as an LAN or WAN network, or any combination thereof and can also include PSTN or ISDN sub-networks. The network 1060 can also be wired, such as an Ethernet network, or can be wireless such as a cellular network including EDGE, 3G, 4G and 5G wireless cellular systems. The wireless network can also be Wi-Fi, Bluetooth, or any other wireless form of communication that is known.

The computing device further includes a display controller 1008, such as a NVIDIA GeForce GTX or Quadro graphics adaptor from NVIDIA Corporation of America for interfacing with display 710, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners, such as an OfficeJet or DeskJet from Hewlett Packard.

A sound controller 1020 is also provided in the computing device such as Sound Blaster X-Fi Titanium from Creative, to interface with speakers/microphone 1022 thereby providing sounds and/or music.

The general-purpose storage controller 1024 connects the storage medium disk 1004 with communication bus 1026, which may be an ISA, EISA, VESA, PCI, or similar, for interconnecting all of the components of the computing device. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

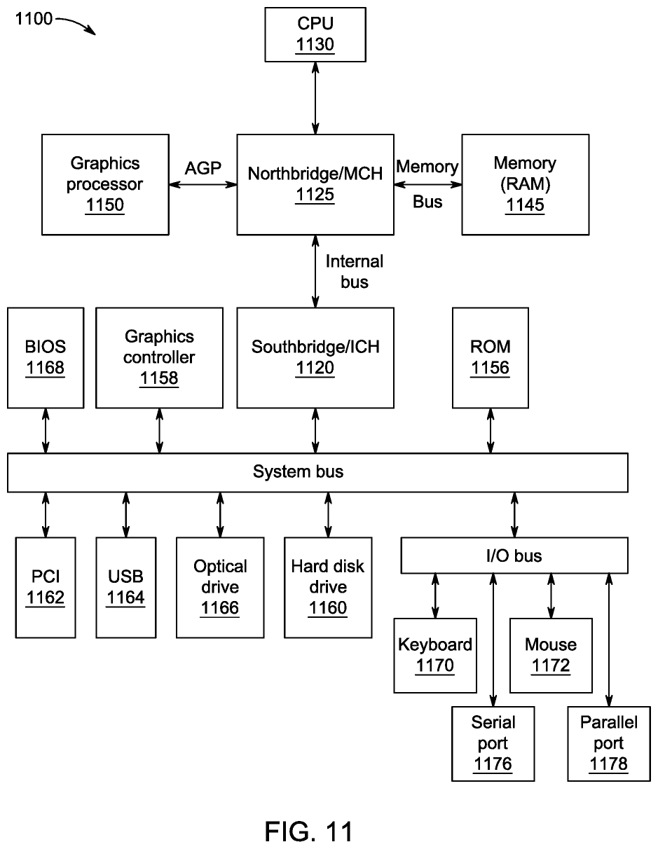

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 11.

FIG. 11 shows a schematic diagram of a data processing system 1100, according to certain embodiments, for performing the functions of the exemplary embodiments. The data processing system 1100 is an example of a computer in which code or instructions implementing the processes of the illustrative embodiments may be located.

In FIG. 11, data processing system 1100 employs a hub architecture including a north bridge and memory controller hub (NB/MCH) 1125 and a south bridge and input/output (I/O) controller hub (SB/ICH) 1120. The central processing unit (CPU) 1130 is connected to NB/MCH 1125. The NB/MCH 1125 also connects to the memory 1145 via a memory bus, and connects to the graphics processor 1150 via an accelerated graphics port (AGP). The NB/MCH 1125 also connects to the SB/ICH 1120 via an internal bus (e.g., a unified media interface or a direct media interface). The CPU Processing unit 1130 may contain one or more processors and even may be implemented using one or more heterogeneous processor systems.

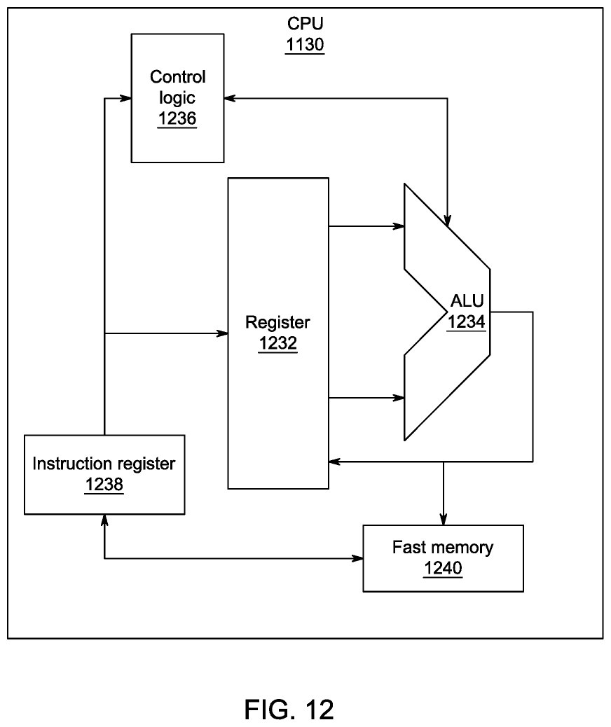

For example, FIG. 12 shows one implementation of CPU 1130, according to an embodiment. In one implementation, the instruction register 1238 retrieves instructions from the fast memory 1240. At least part of these instructions are fetched from the instruction register 1238 by the control logic 1236 and interpreted according to the instruction set architecture of the CPU 1130. Part of the instructions can also be directed to the register 1232. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1234 that loads values from the register 1232 and performs logical and mathematical operations on the loaded values according to the instructions. The results from these operations can be feedback into the register and/or stored in the fast memory 1240. According to certain implementations, the instruction set architecture of the CPU 1130 can use a reduced instruction set architecture, a complex instruction set architecture, a vector processor architecture, a very large instruction word architecture. Furthermore, the CPU 1130 can be based on the Von Neuman model or the Harvard model. The CPU 1130 can be a digital signal processor, an FPGA, an ASIC, a PLA, a PLD, or a CPLD. Further, the CPU 1130 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 11, the data processing system 1100 can include that the SB/ICH 1120 is coupled through a system bus to an I/O Bus, a read only memory (ROM) 1156, universal serial bus (USB) port 1164, a flash binary input/output system (BIOS) 1168, and a graphics controller 1158. PCI/PCIe devices can also be coupled to SB/ICH 888 through a PCI bus 1162.

The PCI devices may include, for example, Ethernet adapters, add-in cards, and PC cards for notebook computers. The Hard disk drive 1160 and CD-ROM 1166 can use, for example, an integrated drive electronics (IDE) or serial advanced technology attachment (SATA) interface. In one implementation the I/O bus can include a super I/O (SIO) device.

Further, the hard disk drive (HDD) 1160 and optical drive 1166 can also be coupled to the SB/ICH 1120 through a system bus. In one implementation, a keyboard 1170, a mouse 1172, a parallel port 1178, and a serial port 1176 can be connected to the system bus through the I/O bus. Other peripherals and devices that can be connected to the SB/ICH 1120 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

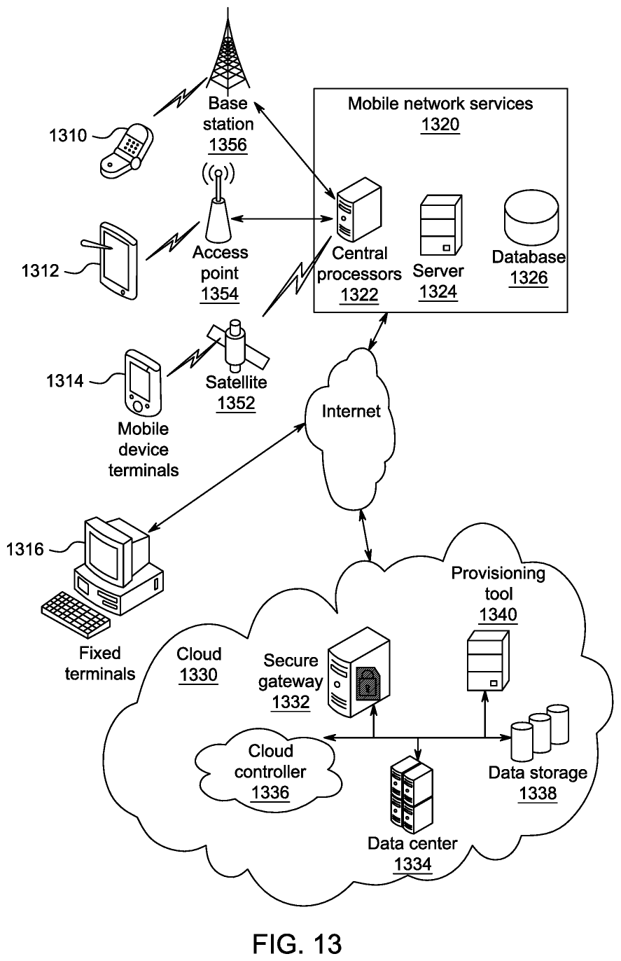

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 13, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A method of detecting road anomalies, the method comprising:
obtaining visual data from an end computing device in a vehicle travelling on a road, wherein the visual data is a live feed captured using a camera associated with the end computing device;
inputting the visual data to a machine learning (ML) model trained to detect and classify a road anomaly, wherein the road anomaly includes a pothole, longitudinal cracks, transverse cracks, or alligator cracks on the road;
determining multiple features of the detected road anomaly, wherein the features include a size of the road anomaly;
assessing a severity of the road anomaly based on the features; and
transmitting, via a roadside computing device installed on the road, a notification to multiple end computing devices in the proximity of the roadside computing device, wherein the notification is an anomaly-specific notification that includes at least one of a message indicating a presence of the road anomaly, an image of the road anomaly, a location of the road anomaly, or a severity of the road anomaly.

2. The method of claim 1, wherein the anomaly-specific notification includes the severity, and the severity is determined based on the size of the road anomaly, and wherein the size is determined based on dimensions of a smallest bounding box that encloses a portion of a frame of the visual data having the road anomaly.

3. The method of claim 2, wherein the severity is determined to be of a first value when an area of the bounding box exceeds a specified threshold area and of a second value when the area does not exceed the specified threshold area, wherein the first value is indicative of a more severe road anomaly than the second value, and wherein the specified threshold area is determined as a percentage of an area of the frame.

4. The method of claim 1, further comprising:
determining a count of road anomalies detected in a sequence of frames of the visual data, wherein determining the count includes:
determining a frame span interval (FSI) based on frames per second of the camera and speed of the vehicle,
determining a specified number of frames to be skipped from multiple frames of the visual data based on the FSI, wherein the specified number of frames to be skipped when the FSI is greater than a specified threshold is lesser than the specified number of frames to be skipped when the FSI is lesser than the specified threshold, and
selecting a next frame of the sequence for detecting the road anomaly based on the specified number of frames to be skipped.

5. The method of claim 1, wherein transmitting the notification comprises:
determining that a count of road anomalies detected exceeds a specified threshold, and
sending a general notification to the end computing devices in the proximity of the roadside computing device, wherein the general notification is indicative of a presence of multiple road anomalies in the proximity of the end computing devices.

6. The method of claim 1, wherein the ML model is implemented at the end computing device, wherein the end computing device is configured to stream portions of the visual data containing the detected road anomaly to the roadside computing device.

7. The method of claim 1, wherein the ML model is implemented at the roadside computing device, and wherein the end computing device is configured to stream the visual data obtained from the camera to the roadside computing device.

8. The method of claim 1, further comprising:
storing road anomaly data in an electronic storage device, wherein the ML model is implemented at the end computing device, wherein the road anomaly data includes at least one of an image of the road anomaly, a type of the road anomaly, a location of the road anomaly, or a severity of the road anomaly.

9. The method of claim 1, further comprising:
obtaining route data from a first end computing device of the end computing devices, wherein the route data is indicative of a route to be travelled by a first vehicle associated with the first end computing device;
comparing the route data with road anomaly data stored in an electronic storage device to determine a set of road anomalies along the route of the first vehicle; and
transmitting information regarding the set of road anomalies to the first end computing device.

10. The method of claim 1, wherein transmitting the notification comprises:
transmitting the notification based on the severity of the road anomaly matching a specified criterion.

11. The method of claim 1, wherein determining the features include determining a depth of the road anomaly.

12. A non-transitory computer-readable storage medium for storing computer-readable instructions that, when executed by a computer, cause the computer to perform a method, the method comprising:
obtaining visual data from an end computing device installed in a vehicle travelling on a road, wherein the visual data is a live feed captured using a camera associated with the end computing device;
inputting the visual data to a machine learning (ML) model trained to detect and classify a road anomaly, wherein the road anomaly includes a pothole, longitudinal cracks, transverse cracks, or alligator cracks on the road;
determining multiple features of the detected road anomaly, wherein the features include a size of the road anomaly;
assessing a severity of the road anomaly based on the features; and
sending a first signal to a roadside computing device installed on the road to transmit an anomaly-specific notification to multiple end computing devices in the proximity of the roadside computing device, wherein the anomaly-specific notification includes at least one of a message indicating a presence of the road anomaly, an image of the road anomaly, a location of the road anomaly, or a severity of the road anomaly.

13. The non-transitory computer-readable storage medium of claim 12, wherein the severity is determined based on the size of the road anomaly, and wherein the size is determined based on dimensions of a smallest bounding box that encloses a portion of a frame of the visual data having the road anomaly.

14. The non-transitory computer-readable storage medium of claim 13, wherein the severity is determined to be of:
a first value when an area of the bounding box exceeds a specified threshold area, and
a second value when the area does not exceed the specified threshold area, wherein the first value is indicative of a more severe road anomaly than the second value, wherein the specified threshold area is determined as a percentage of an area of the frame.

15. The non-transitory computer-readable storage medium of claim 12, wherein the method further comprises:
determining a count of road anomalies detected in the visual data based on a frame span interval (FSI) metric.

16. The non-transitory computer-readable storage medium of claim 15, wherein the method of determining the count includes:
determining the FSI based on frames per second of the camera and speed of the vehicle,
determining a specified number of frames to be skipped from multiple frames of the visual data based on the FSI, and
selecting a next frame of the sequence for detecting the road anomaly based on the specified number of frames to be skipped.

17. The non-transitory computer-readable storage medium of claim 16, wherein the specified number of frames to be skipped when the FSI is greater than a specified threshold is lesser than the specified number of frames to be skipped when the FSI is lesser than the specified threshold.

18. The non-transitory computer-readable storage medium of claim 15, wherein the method further comprises:
determining that the count of road anomalies exceeds a specified threshold, and
sending a second signal to the roadside computing device to transmit a general notification to the end computing devices in the proximity of the roadside computing device, wherein the general notification is indicative of a presence of multiple road anomalies in the proximity of the end computing devices.

19. A system comprising:
a memory storing set of instructions; and
a processor configured to execute the set of instructions to cause the system to perform a method of:
obtaining visual data from an end computing device installed in a vehicle travelling on a road, wherein the visual data is a live feed captured using a camera associated with the end computing device;
inputting the visual data to a machine learning (ML) model trained to detect and classify a road anomaly, wherein the road anomaly includes a pothole, longitudinal cracks, transverse cracks, or alligator cracks on the road;
determining multiple features of the detected road anomaly, wherein the features include a size of the road anomaly;
assessing a severity of the road anomaly based on the features; and
causing a roadside computing device installed on the road to transmit a notification to multiple end computing devices in the proximity of the roadside computing device, wherein the notification includes at least one of a message indicating a presence of the road anomaly, an image of the road anomaly, a location of the road anomaly, or a severity of the road anomaly.

20. The system of claim 19, wherein the method further comprises:
determining a count of road anomalies detected in a sequence of frames of the visual data, wherein determining the count includes:
determining a frame span interval (FSI) based on frames per second of the camera and speed of the vehicle,
determining a specified number of frames to be skipped from multiple frames of the visual data based on the FSI, wherein the specified number of frames to be skipped when the FSI is greater than a specified threshold is lesser than the specified number of frames to be skipped when the FSI is lesser than the specified threshold, and
selecting a next frame of the sequence for detecting the road anomaly based on the specified number of frames to be skipped.
